(19) United States
(12) Patent Application Publication
(10) Pub. No.: US 2011/0200841 A1
(43) Pub. Date: Aug. 18, 2011

(54) SYSTEM FOR THE PRODUCTION OF GRAIN FREE METAL PRODUCTS

(75) Inventor: Fritz Juergen Wisotzki, Darmstadt (DE)

(73) Assignee: Grain Free Products, Inc., Alexandria, VA (US)

(21) Appl. No.: 12/977,061

(22) Filed: Dec. 23, 2010

(30) Foreign Application Priority Data
Dec. 22, 2009 (EP) 09015858

(51) Int. Cl. B32B 15/02; B22D 46/00; B22D 25/02; B32B 15/01; B23P 17/04

(52) U.S. Cl. 428/637; 164/155.7; 428/615; 428/636; 29/527.5

(57) ABSTRACT

A new process and technical arrangement has been established for the production of grain free metal products, which can be extruded directly from the melt, by inserting a seed crystal from a seeding chamber into the opening of the extrusion jet of the melting vessel. The seed crystal will break by contact the surface tension of the liquid metal in the extrusion jet channel, which is slightly undercooled. Upon establishing contact, the temperature at the meeting point of the seed crystal and the liquid metal will be raised by RF-heating to permit the extrusion of the seed crystal backwards, ensuring that metal and seed crystal maintain contact and crystal growth will continue. It has been discovered, that single crystals with the orientation of the seed crystal will continue to grow and to establish high hardness. Speed of extrusion is exceeded to reach only grain free structure in the grown metal.

### CROSS REFERENCE TO RELATED APPLICATION

This application is based on and claims the benefit of European Patent Application No. 09015858.5/EP09015858, filed Dec. 22, 2009, which is incorporated herein by reference.

### BACKGROUND OF THE INVENTION

1. Field of the Invention

The present invention relates to a new process and technical arrangement for the commercially feasible production of grain free metal products, said products being directly extruded from the melt or grown as metal single crystals in a multiple mold, with each grown crystal being mechanically deformed to the desired final form in one direction only.

2. Description of the Prior Art

Presently grain structured metals are directly extruded from the melt from furnaces such as Contirod with a large diameter single rod, which is mechanically deformed into a finer wire, still being at high temperature. The furnaces have an insulation lining of magnesium oxide or other brittle materials, from which smaller grains are embedded into the extruded rod. During the mechanical deformation of, for example, copper, the surface will have oxide layers which are pressed by the deformation process into the copper wire as it can be seen in FIG. 6, showing slags and other impurities inside a fine copper wire, which has been ground to the middle, polished, etched and photographed through a microscope. Further, it has been found that fine wires in cables may contain grains of oxide materials that create so-called hot spots when electric current flows through such a cable. If such a high resistance hot spot is in a bend of a cable in an aircraft where vibration is present, the fine wire may break and create an arc. Such an arc will melt the neighboring wires, and in no time a cable fire is there. If in the worst scenario something volatile is nearby, for example fuel, an explosion may happen during flight. A good number of aircraft and lives have been lost this way, and presently aircraft manufacturers install warning systems for electrical arcing, increasing the weight of the aircraft. In some countries where light materials such as wood are used in house building, such high resistance hot spots are the main cause for fires. For other applications, for example to reach high tensile strength, as it is required for high speed electrical trains in the overhead conductor, producers alloy the copper conductor with cadmium and beryllium to reach a high tensile strength, but at the same time lose a good portion of the electrical conductivity of the grain structured copper. On arcing as it happens during wet and cold seasons, those arcs create abrasion of metal like spark erosion, and the eroded material is in the air changed into beryllium oxide and cadmium oxide, infecting the air and the soil near the train track or in the cities where trams and trolley buses are used, the area near by. As it can be seen in FIG. 7, the impurities do infect in tensile tests the breaking of the grain structured wire, which is a high indication of the unreliability. The contrary is shown in FIG. 8 and FIG. 9, displaying the inside of a grain free copper wire, before and after the pulling test.

The same is shown in FIG. 10 in a tensile test comparison of grain structured copper wire and single crystal copper wire. The single crystal wire has, due to the later described production process, a far higher tensile strength of 65% above the grain structured wire, and breaks always at the same point of pulling length, the most impressive result of reliability. At the bottom line under the pulling results of the grain structured wire, variation in pulling length indicate the high unreliability of the grain structured wire.

Finally, oxidation of metals comes from the impurities inside the grain structure, caused by the light elements, which reside as impurities between the grains, in the so called grain boundaries. From there corrosion takes place, covering the surface of the product and eating the metal away, by changing it into an oxide.

### SUMMARY OF THE INVENTION

The present invention is a new process and technical arrangement for the production of grain free metal products, which can be extruded directly from the melt, by inserting first a seed crystal from a seeding chamber into the opening of the extrusion jet of the melting vessel. The seed crystal will break by contact the surface tension of the liquid metal in the extrusion jet channel, which is slightly under cooled. Upon established contact the temperature at the meeting point of the seed crystal and the liquid metal will be raised by RF-heating to permit the extrusion of the seed crystal backwards, ensuring that metal and seed crystal maintain contact and crystal growth will continue. It has been discovered that single crystals with the orientation of the seed crystal will continue to grow and to establish a high hardness, speed of extrusion increased to reach only a grain free structure in the grown metal. Forms are dictated by the shape of the extrusion jet orifice and the melting vessel, as shown in FIG. 1, permits up to six extrusion jets to be installed, which again permit different forms to be extruded at the same time as shown in FIG. 2 and FIG. 3.

Accordingly, it is a principal object of the invention to provide metals that have greater tensile strength.

It is another object of the invention to provide metals that are resistant to oxidation.

It is a further object of the invention to provide metals that have greater electrical conductivity.

Still another object of the invention is to provide metals that have greater thermal conductivity.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front view of the preferred embodiment of the invention.

FIG. 2 is a top view of the preferred embodiment of the invention.

FIG. 3 shows possible profiles of grain free metals directly extruded from the melt.

FIG. 4 illustrates directional deformation of metal single crystals.

FIG. 5 illustrates grain free cable cross sections.

FIG. 6 is a microphotograph of a cross section of grain structured copper wire.

FIG. 7 is a microphotograph of a broken end of grain structured copper wire.

FIG. 8 is a microphotograph of a cross section of grain free copper wire.

FIG. 9 is a microphotograph of a broken end of grain free copper wire.

FIG. 10 is a graph comparing the pulling strength of grain structured and grain free wires.

FIG. 11 is a microphotograph showing the surface of grain structured metal.

FIG. 12 is a microphotograph showing the surface of grain free metal.

FIG. 13 is a photograph of grain free rods and wire.

FIG. 14 is a photograph of grain structured and grain free pieces of wire embedded in plastic.

FIG. 15 is a microphotograph of a cross section of grain structured aluminum wire.

FIG. 16 is a microphotograph of a cross section of grain free aluminum wire.

FIG. 17 is a photograph showing direct extrusion of grain free metal from the melt.

Similar reference characters denote corresponding features consistently throughout the attached drawings.

### DETAILED DESCRIPTION OF THE PREFERRED EMBODIMENT

Generally, it has been manifested that single crystal and grain free metals do not oxidize unless they are infected by seeds on the surface, which show up as stains first and gradually turn into oxidation. Further, single crystal metals and grain free metals do have a significant higher thermal and electrical conductivity, which has been measured on copper to be 7.5% for electrical conductivity and 18% for thermal conductivity, but the most interesting finding is the high speed of thermal transfer through a crystal or grain free body, from the surface into a cooling media.

Developing from the basis of those findings a sensible production method to reach a commercial feasible way of production has been the task for which patent protection is applied for.

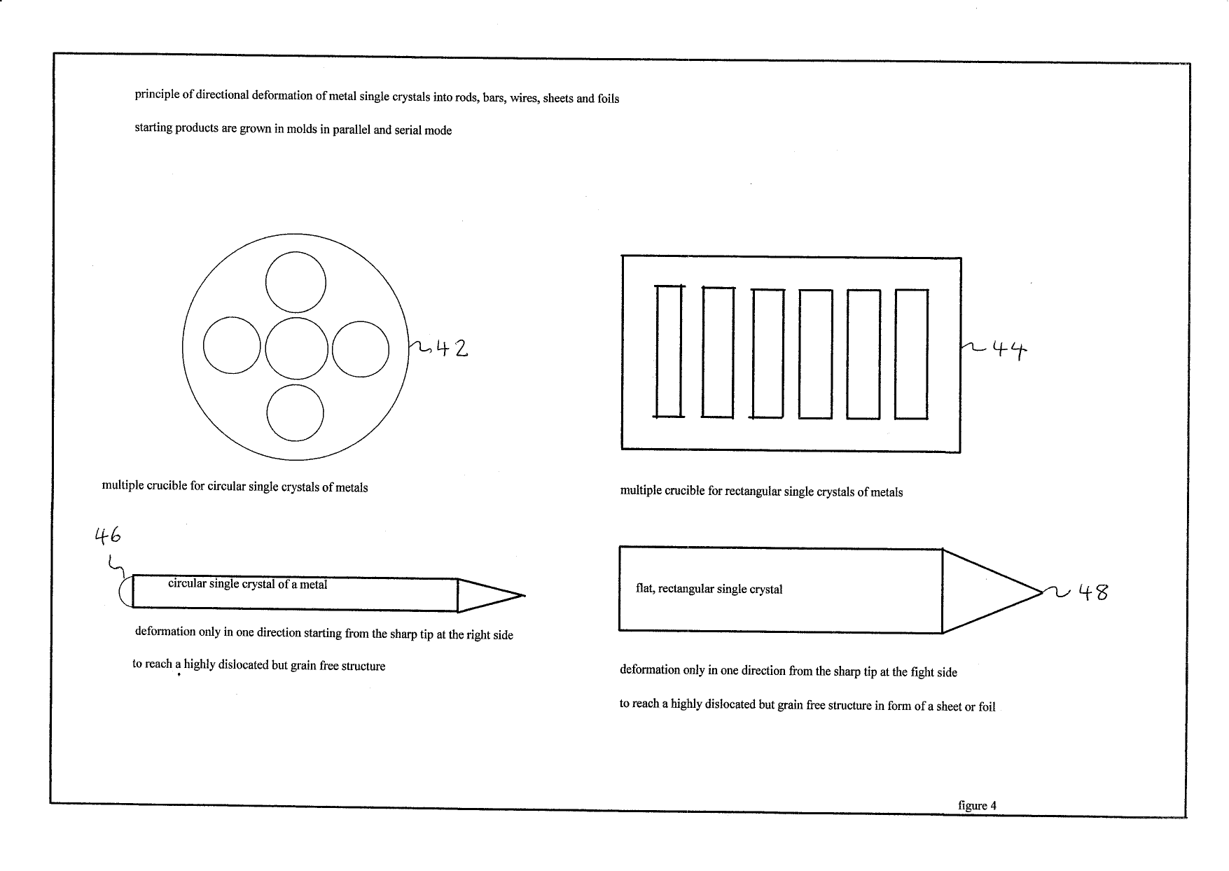

First of all, a method was developed to grow in one process cycle a greater number of single crystals in one mold, having a circular shape, or rectangular shape, with adequate dimensions. Deforming those crystals as shown in FIG. 4 in one direction only, will not alter the high density single crystal structure, only change it into a grain free structure, because of the high dislocation density.

Those deformed crystals have still the same higher electrical and thermal conductivity that was found in copper, but on top of that, the tensile strength has also been increased significantly, to the level of 65% above alloyed grain structured copper, good enough to be used as conductor for electrical trains, trams and trolley buses.

This directional deformation process of single crystal metals of aluminum, copper, gold and silver permits the production of foils down to a thickness below one micron without having any pin holes or other cuts in the foil, because there are no brittle or otherwise harder inclusions in the single crystal metal.

Even though this production process permits highest quality products with a grain free structure and their technical advantages over a grain structured metal, it always requires a process to grow single crystals as shown in FIG. 4.

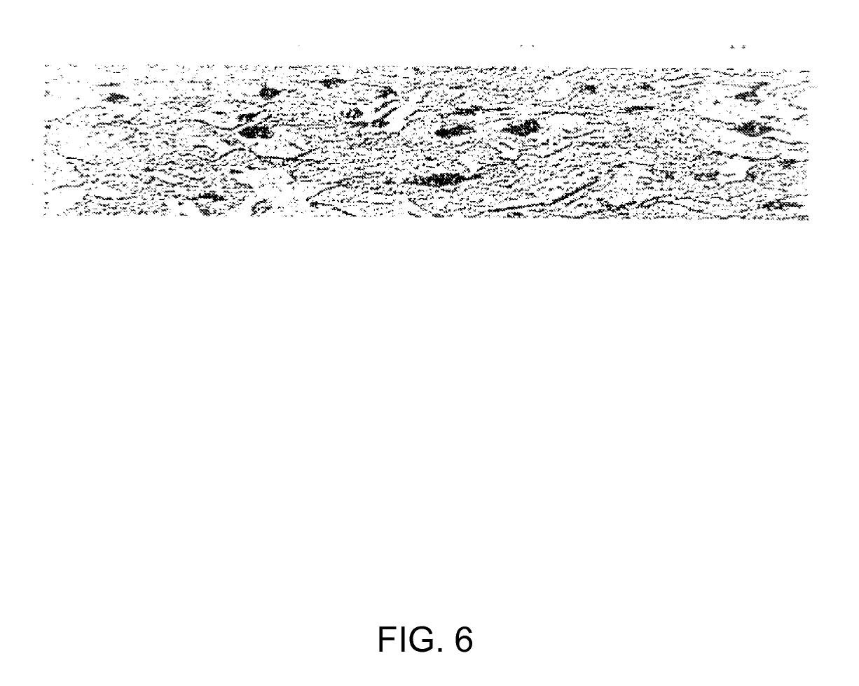

FIG. 6 demonstrates the difference in surface density between a grain structured copper conductor for electrical trains and a similar surface profile of grain free copper, which explains why grain free metals have a higher reliability.

The inventor learned from failures during a Czochralski growth of metal crystals, that regardless how fast he was pulling the seed crystal upwards away from the melt, the remaining connection with between seed crystal and melt still had a grain free structure, becoming very thin, well below 0.1 mm, until gravity broke that connection between seed crystal and melt.

A significant feature of the invention is the use only of stainless steel, high purity graphite, high purity boron nitride and an inert gas atmosphere to ensure that there are no enclosures whatsoever in the grain free metal product.

Using the gravity and the capillary force as a support, it was tried to extrude at the bottom of a melting vessel materials, such as semiconductors and metals and any thickness or diameter could be continuously extruded until the pressure from the weight of the melt in the vessel was not high enough anymore to force the material into the extrusion jets' orifice.

The next step in this invention was to ensure a constant inflow of liquid metal or semiconductor material into the melting vessel of the main chamber to maintain a constant pressure at the orifice of the extrusion jets. The more material extruded, the more material had to be fed into the melting vessel.

Without contacting the waiting melt in the orifice of the extrusion jet with a seed crystal, nothing would flow out through the orifice of the extrusion jet, caused by the capillary force and the surface tension of a liquid material.

Each extrusion jet has a fine gradient control by Radio Frequency heating and whilst the seed crystal is brought into position to contact the waiting melt, the waiting melt is slightly undercooled, a little below the melting point of the material. As the seed crystal gets into mechanical contact with the waiting melt, the temperature at that meeting point is gradually raised, until a portion of the seed crystal is melted and a good connection between the seed crystal structure and the melt has been established.

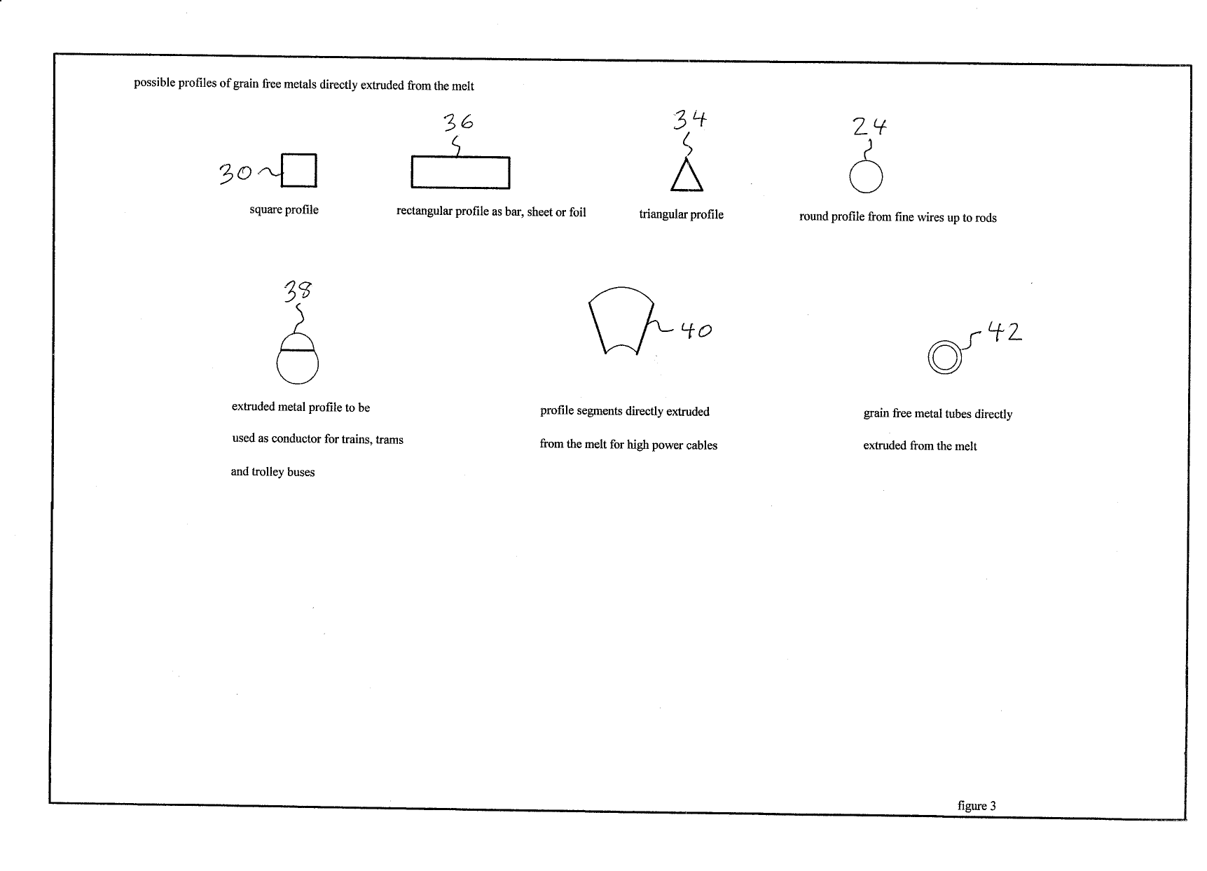

From this point on, the seed crystal chamber is gradually removed at a low speed from the melting vessel's chamber, extending the seed crystal continuously, and the mouth of the orifice of the extrusion jet gives the growing crystal the required form of any nature as shown in FIG. 3.

The temperature is dropped within the extrusion jet chamber significantly, and when the growing crystal comes to air, the material will be at room temperature, thus ensuring that there will be no oxide coating, with the exception of the metal aluminum.

If the inspector is satisfied with the contact between the seed crystal and the melt, the speed is increased significantly, coming near the speed of the Contirod System, but still maintaining a grain free structure of the extruded material.

The gauge control ensures that an inflow of material is taking place in the same quantity as the extruded material is reducing the level of liquid material in the melting vessel of the main chamber.

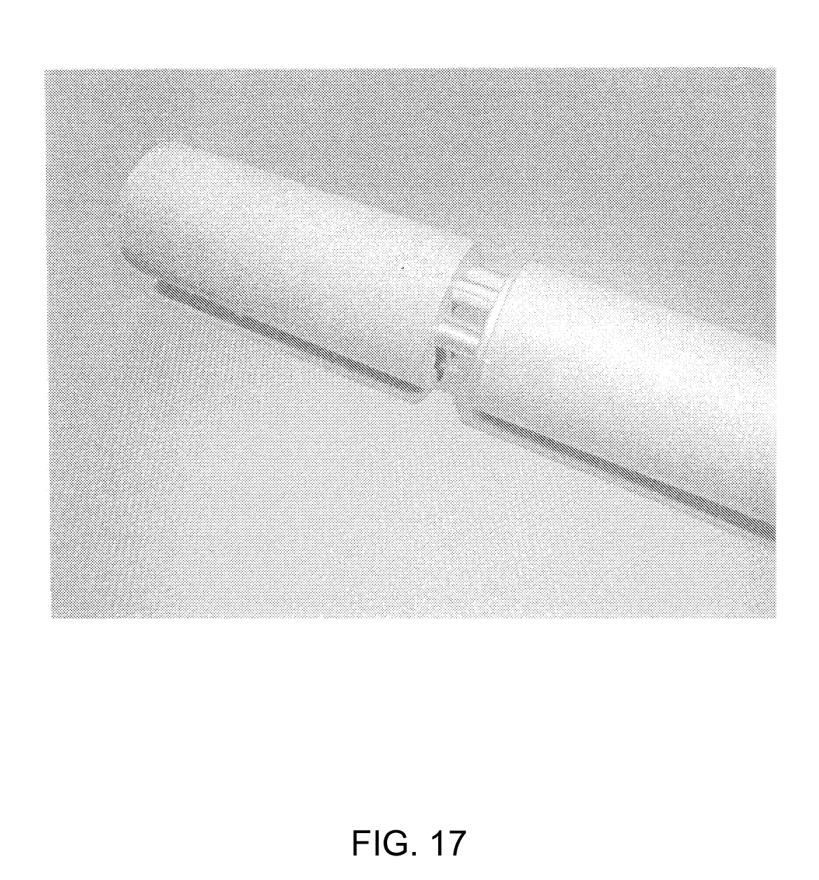

FIG. 17 shows an arrangement of such an extrusion principle. If the seed crystal chamber on the left side of the picture is rotated, a cable can be wound and insulation can be added.

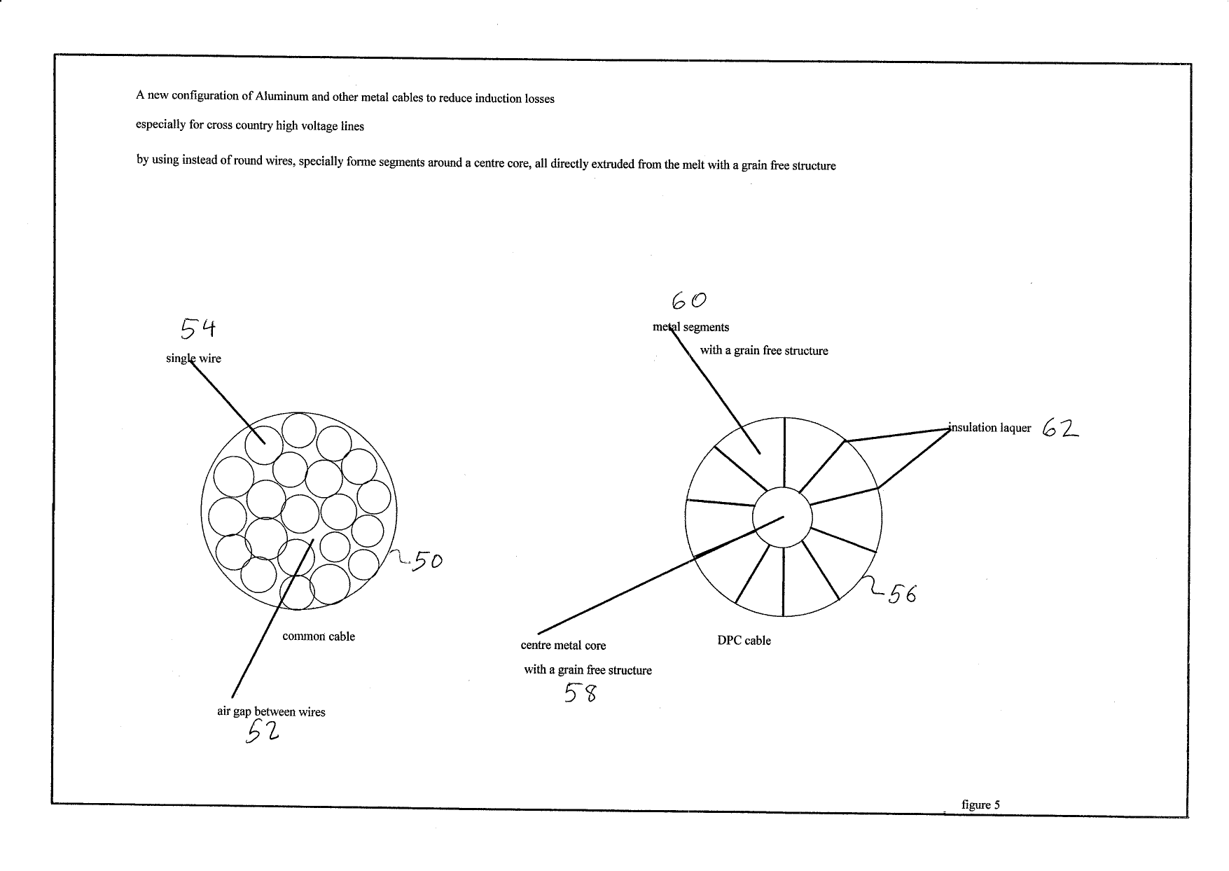

Another option has been developed to avoid losses of energy by induction between the single wires in such a wound cable, by extruding profiles around a core and forming those to a complete wire as shown in FIG. 5.

What has been working in a single mode process using only one extrusion jet works similar with a greater number of extrusion jets. From practical experience the number of extrusion jets on one melting vessel has been limited to six extrusion jets. Each of the six extrusion jets can produce a different product, such as foils of different thickness and wires or profiles. The only mandatory requirement is the constant feed of liquid material into the melting vessel in the amount, as material is extruded at the extrusion jets.

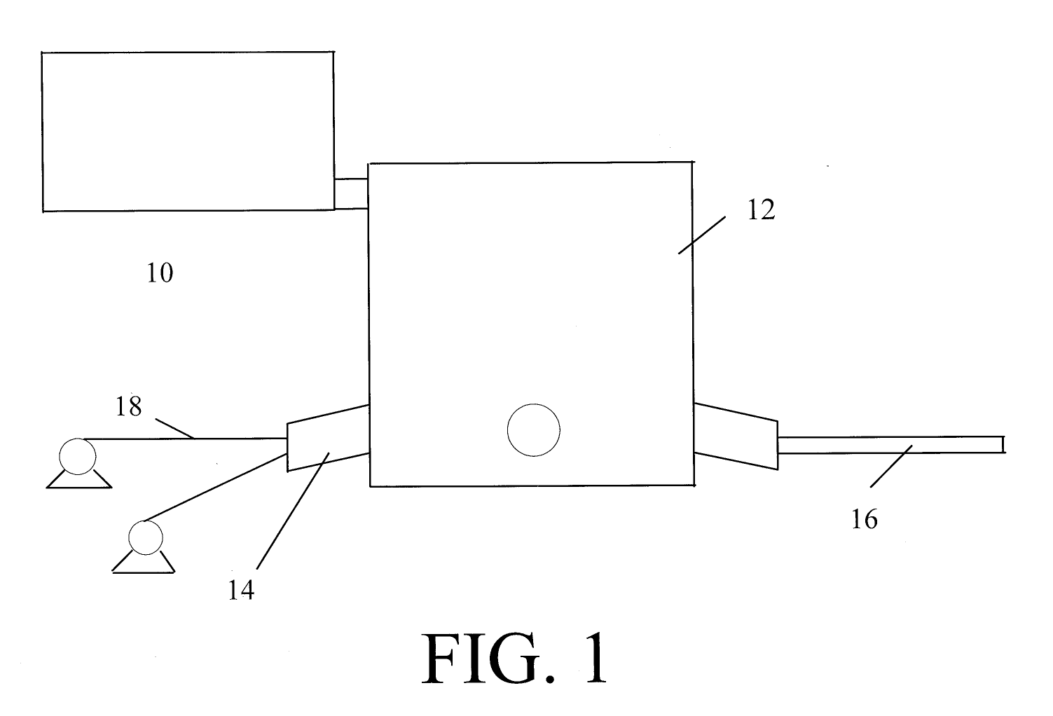

FIG. 1 shows a continuous extrusion system for profiles, rods, foils, sheets and tubes of metals such as aluminum, copper, gold, silver, and a variety of other metals. The liquid and purified metal flows from the liquefier and purification system 10 into the liquid metal container 12 in the same quantity as it is extruded at the extrusion jets 14. The system permits operation of one extrusion jet with one product only, but has ports for six extrusion jets. Each extrusion jet can produce one or several profiles 16. Several wires can be wound directly into a cable. It can produce wire with a diameter as small as 0.1 millimeter or foils 18 with a thickness of 40 microns.

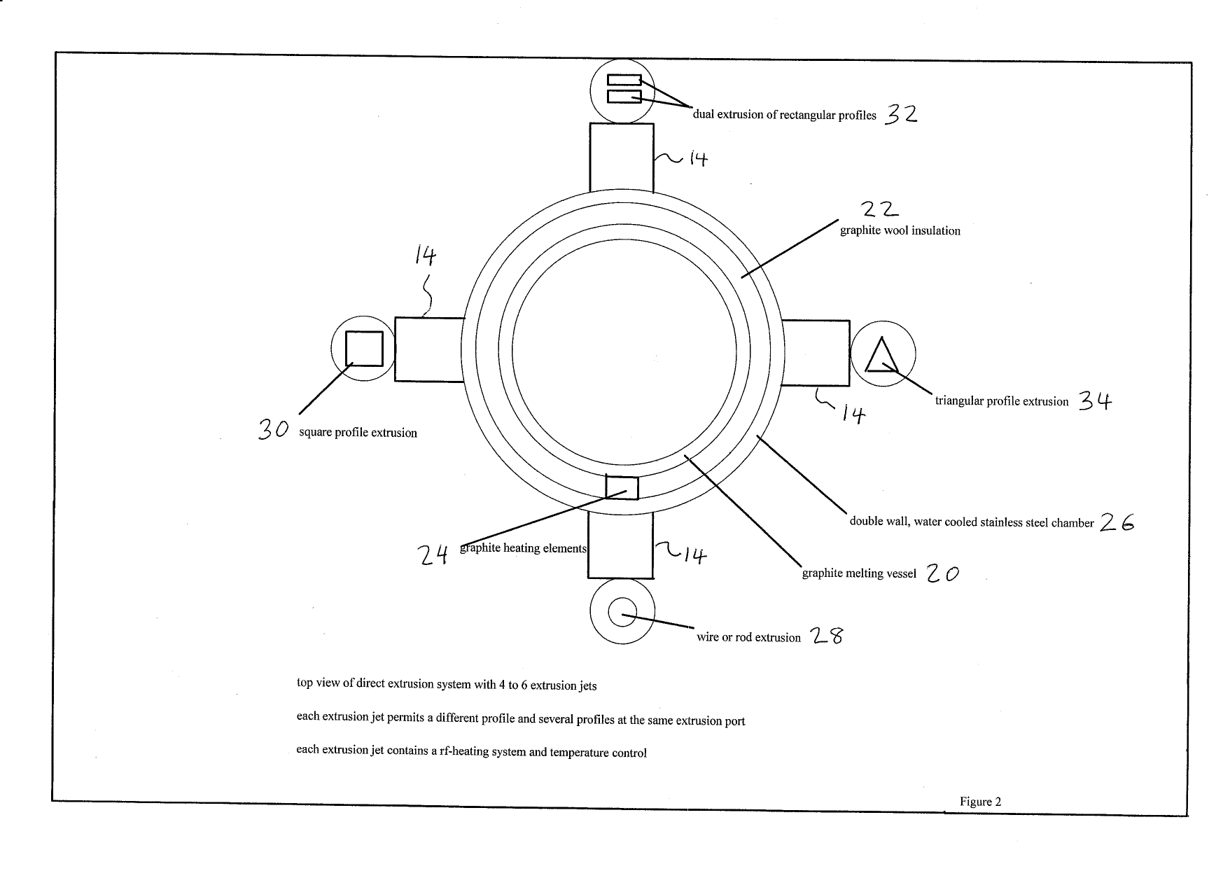

FIG. 2 is a top view of the direct extrusion system with four to six extrusion jets. Each extrusion jet permits a different profile and several profiles at the same extrusion port. Each extrusion jet contains an RF-heating system and temperature control. A graphite melting vessel 20 is surrounded by graphite wool insulation 22 and graphite heating elements 24, which are surrounded by a double wall, water cooled stainless steel chamber 26. Possible profiles include profiles for wire or rod extrusion 28, square profile extrusion 30, dual extrusion of rectangular profiles 32, and triangular profile extrusion 34.

FIG. 3 shows possible profiles of grain free metals directly extruded from the melt, including the square profile 30, a rectangular profile 36 for bars, sheets or foils, the triangular profile 34, round profiles 28 ranging from those for fine wires up to those for rods, an extruded metal profile to be used as a conductor from trains, trams and trolley buses 38, profile segments directly extruded from the melt for high power cables 40, and grain free metal tubes directly extruded from the melt.

FIG. 4 shows the principle of directional deformation of metal single crystals into rods, bars, wires, sheets and foils. Starting products are grown in molds in parallel and serial mode. Shown are a multiple crucible for circular single crystals of metals 42, a multiple crucible for rectangular single crystals of metals 44, a circular single crystal of a metal 46 (with deformation in one direction starting from the sharp tip at the right side to reach a highly dislocated but grain free structure) and a flat, rectangular single crystal 48 (with deformation only in one direction from the sharp tip at the right side to reach a highly dislocated but grain free structure in the form of a sheet or foil).

FIG. 5 shows a new configuration of aluminum and other metal cable to reduce induction losses, especially for cross country high voltage lines, by using, instead of round wires, specially formed segments around a center core, all directly extruded from the melt with a grain free structure. The common cable 50 has air gaps 52 between the wires 54 that make up the cable. The new DPC cable 56 has a central metal core 58 with a grain free structure, surrounded by metal segments 60 also having a grain free structure, with insulation laquer 62 between the segments.

FIGS. 6 through 9 show the visible difference in quality between OFHC-copper and grain free copper. FIG. 6 is a microphotograph of the cross section of a grain structured copper wire from a cable used in aircraft. The wire was polished, etched and photographed through a microscope. The black spots are slag enclosures and the thin black lines are further impurities in the grain boundaries, that are barriers to electrical and thermal conductivity.

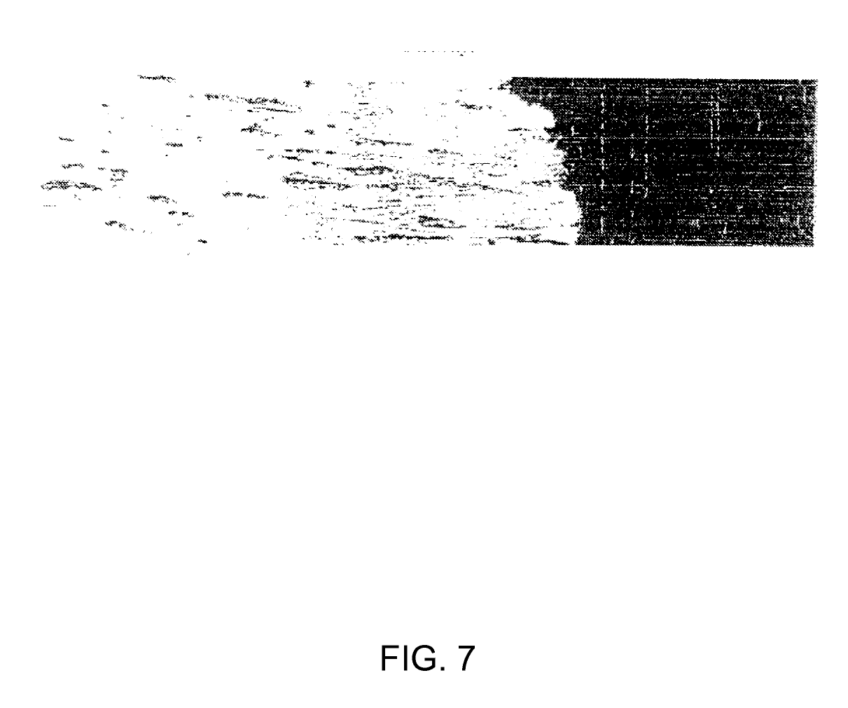

FIG. 7 is a microphotograph of the broken end of a grain structured wire after a tensile strength test. The maximum strength was 365 newtons per square millimeter, and the variations in pulling length were between 105 to 115 millimeters. To change tensile strength in a positive way, the OFHC-Copper needs to be alloyed and this will influence and reduce the electrical conductivity.

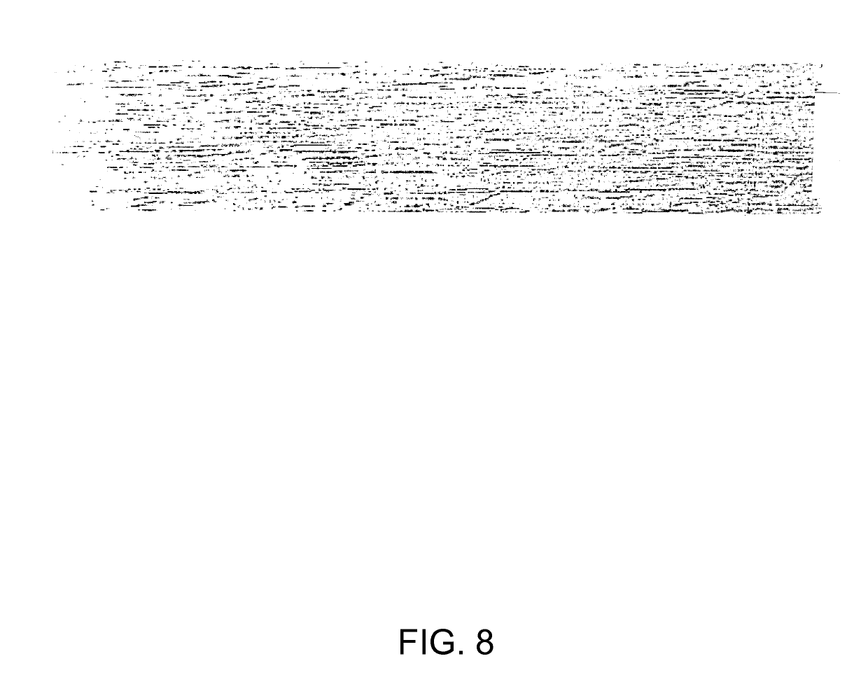

FIG. 8 is a microphotograph of a grain free copper wire, treated in the same way as the above shown OFHC-copper wire and photographed through a microscope at the same magnification. The scratches are from polishing material. There are no slag enclosures and no impurities and no grain boundaries!

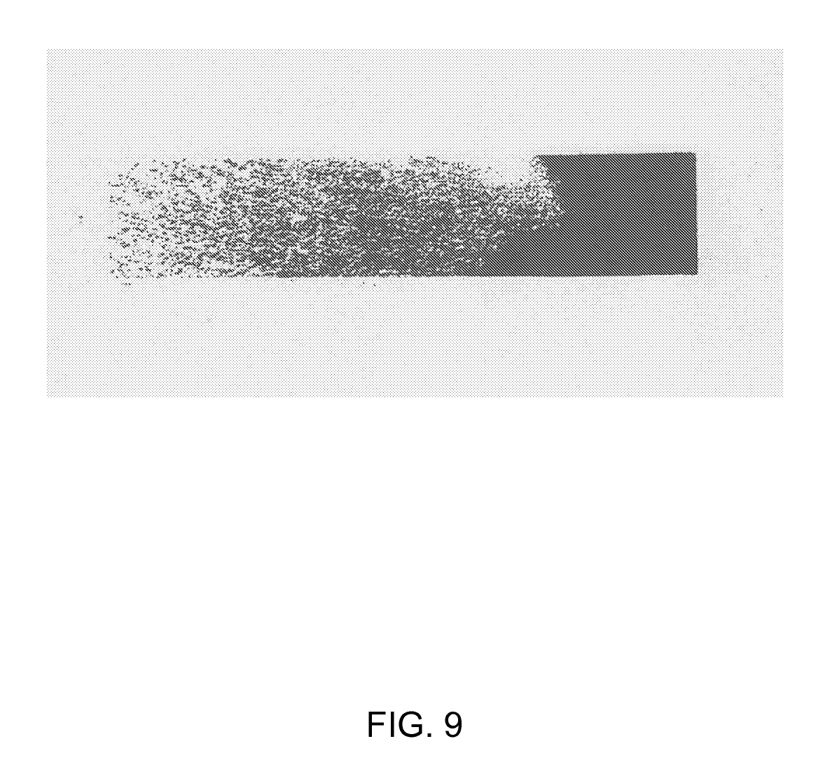

FIG. 9 is a microphotograph of a grain free copper wire after a tensile test, reaching a pulling strength of 665 newtons per square millimeter, almost double the strength reached in the OFHC-copper wire. There were no variations in the results of the test, as each wire broke at the same pulling length of ten millimeters, caused by the high purity and missing grains. The high purity guarantees highest conductivity, leaving room for weight and diameter reduction.

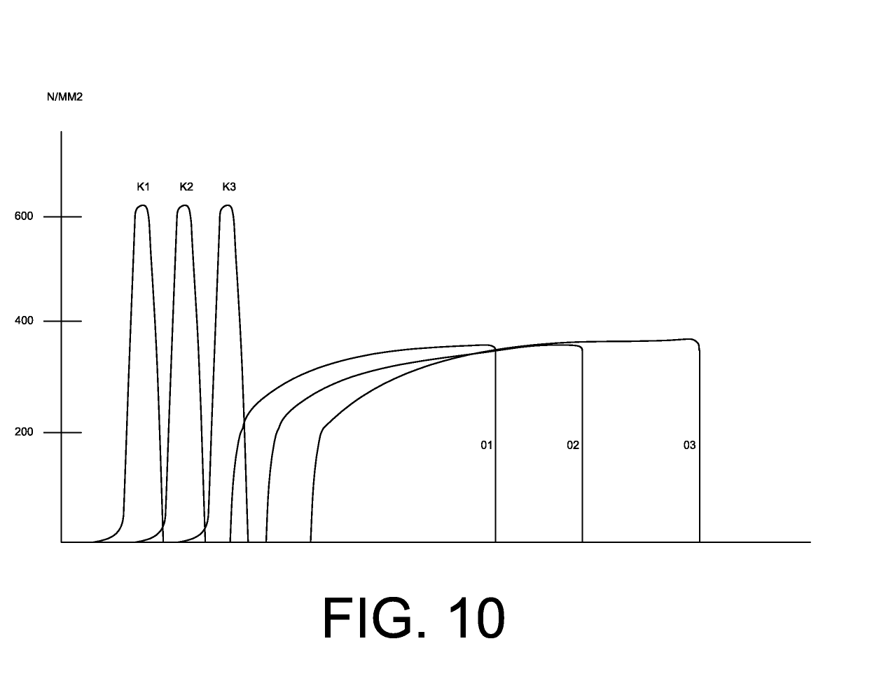

FIG. 10 is a graph with curves that represent the pulling strength of each wire in newtons per square millimeter. Curves K1, K2 and K3 are the curves of 1.29 millimeter diameter single crystal wire, which resisted a pulling strength up to 650 newtons per square millimeter, and when they broke, always at the same length of expansion, shown at the bottom of the curves, a sign of the highest reliability. The curves O1, O2 and O3 represent the pulling strength of 1.29 millimeter diameter OFHC-wire with a grain structure. The reached pulling strength of 365 newtons per square millimeter is the maximum pulling strength such a wire will resist without adding an alloy, which will reduce its electrical conductivity. The variation in pulling length indicates the unreliability of the grain structure.

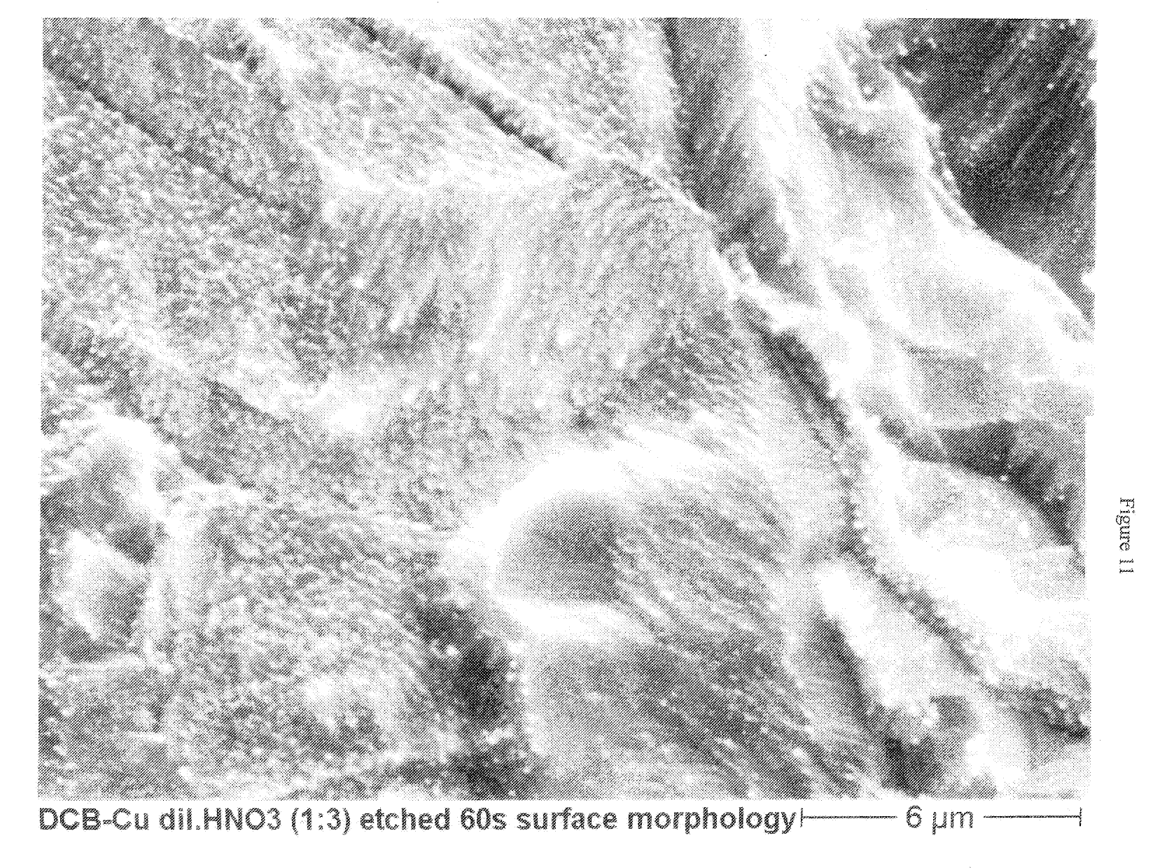

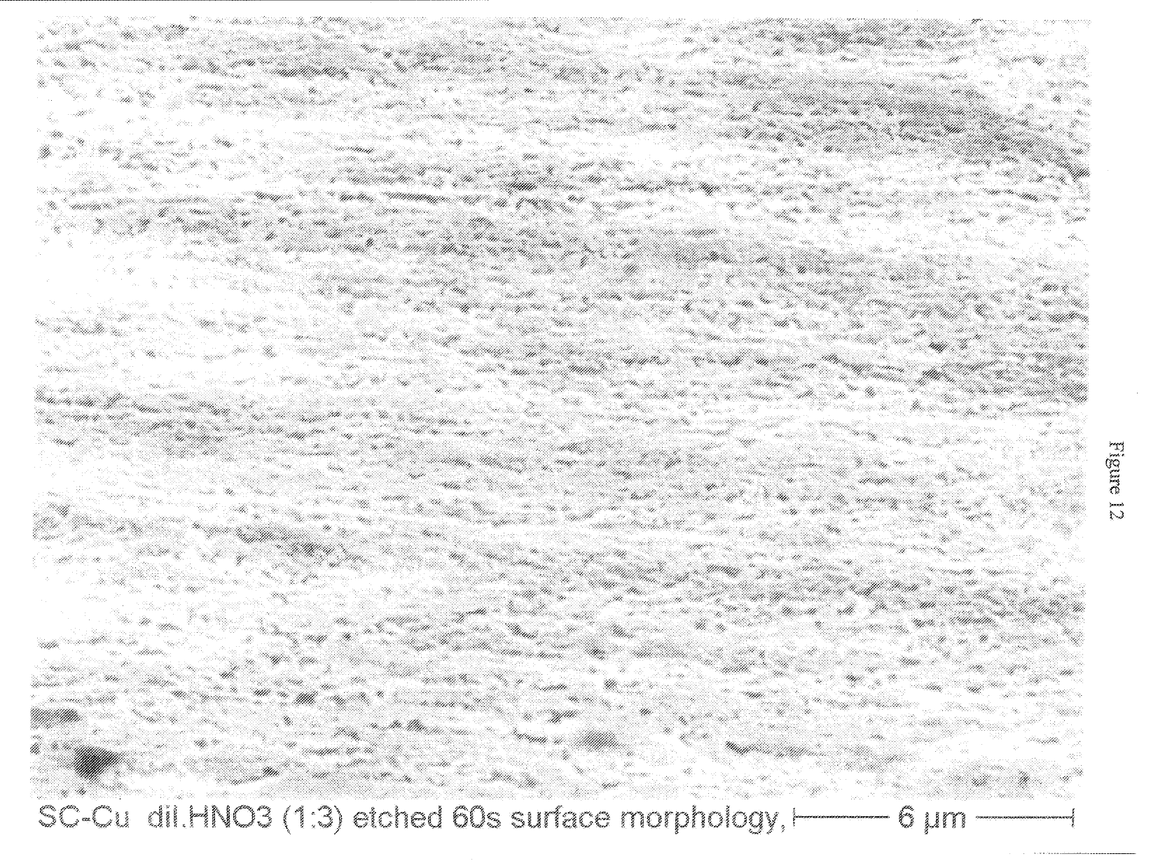

Another demonstration of the well higher quality is given in FIGS. 11 and 12 in which high purity aluminum was grown into single crystals, which were deformed into wires. Pieces of the wires were ground down to the middle, polished and etched and photographed through a microscope. The difference in density is shown in FIGS. 11 and 12 and is self explanatory.

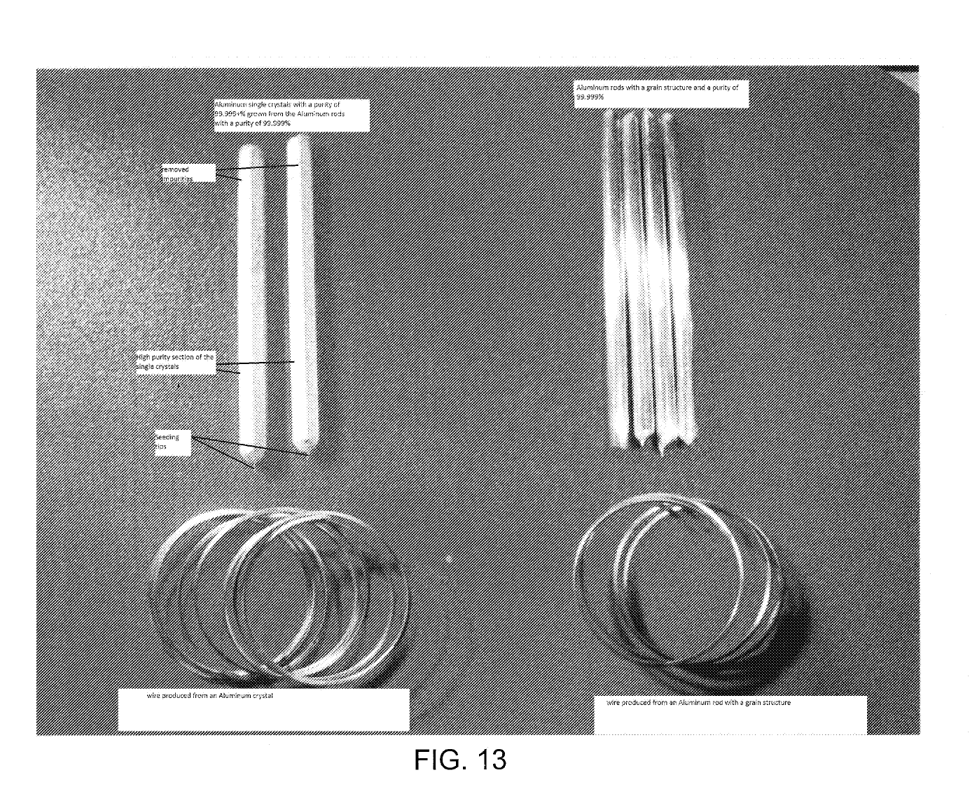

The rods in FIG. 13 present aluminum with a purity of 99.999%, from which the lower wire has been formed, and also some single crystals of aluminum were grown from. One single crystal was deformed into a wire. The picture was taken with one flash, and one can see the white color of the aluminum crystals that demonstrates the higher density of the crystal structure. The fine tips at one end of the rods are the seeding point from which the crystal starts to grow. Any impurities, in particular light elements, will be removed during the process from the tips to the other end of the crystal.

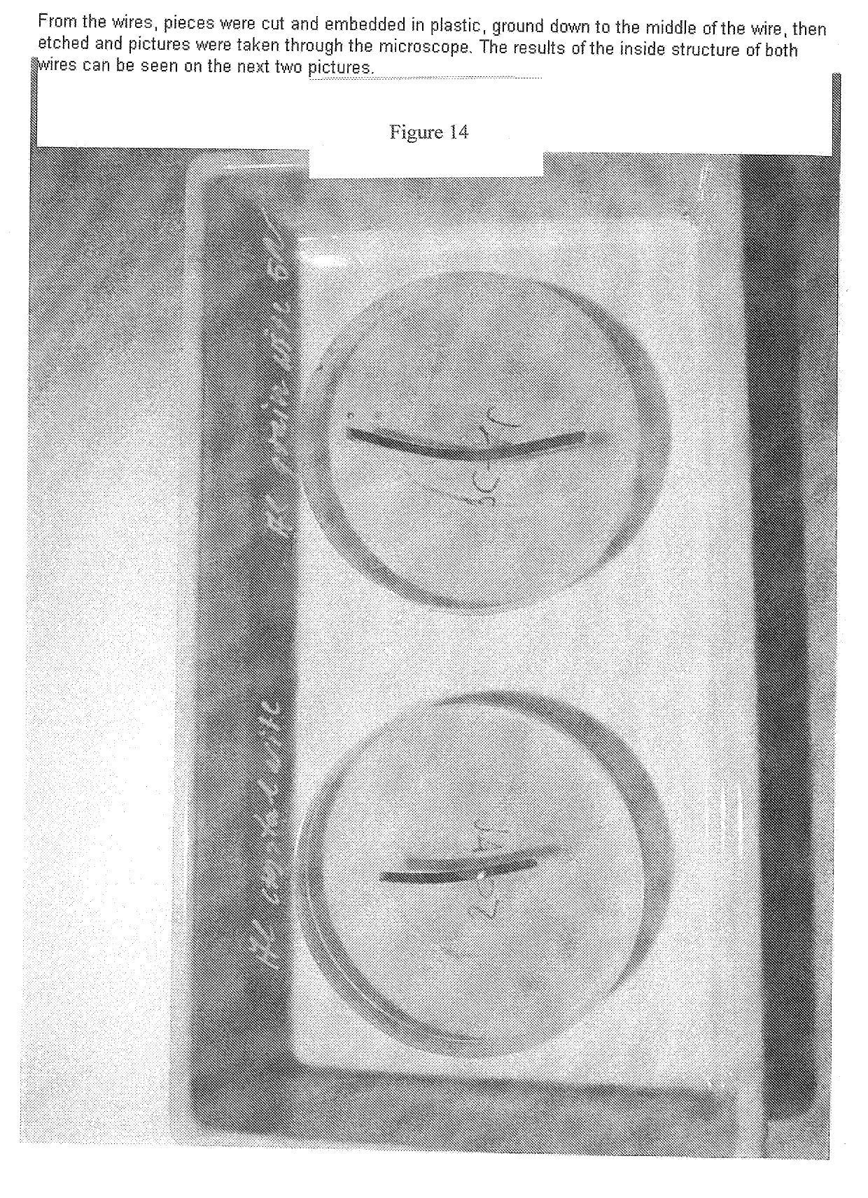

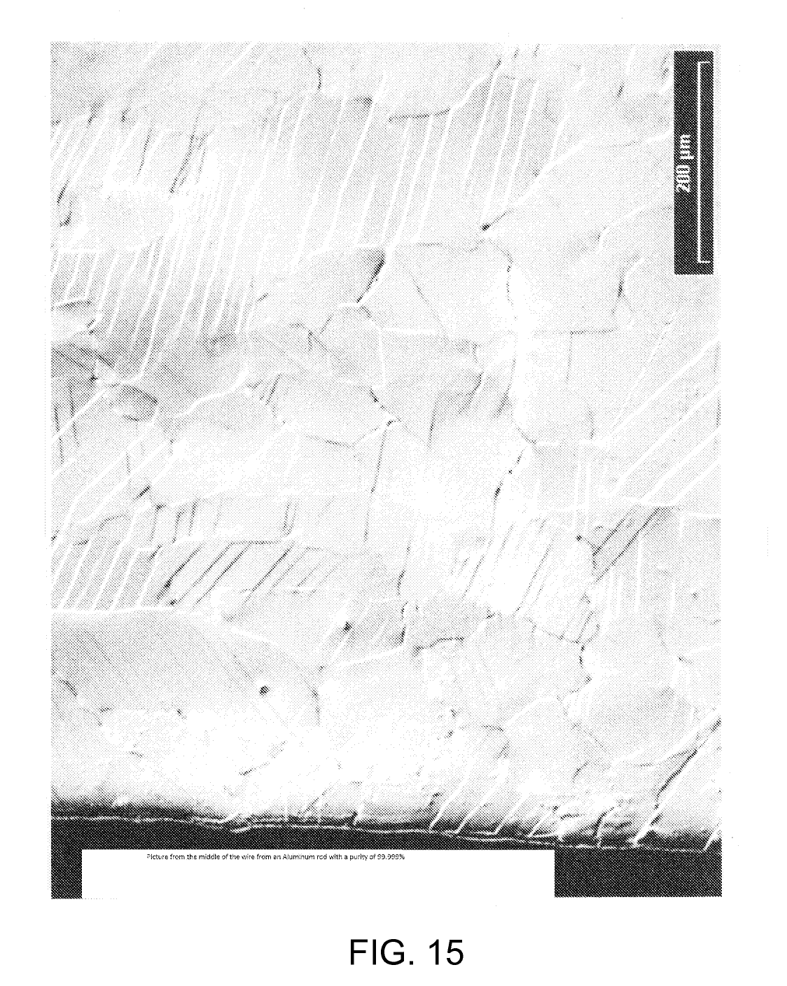

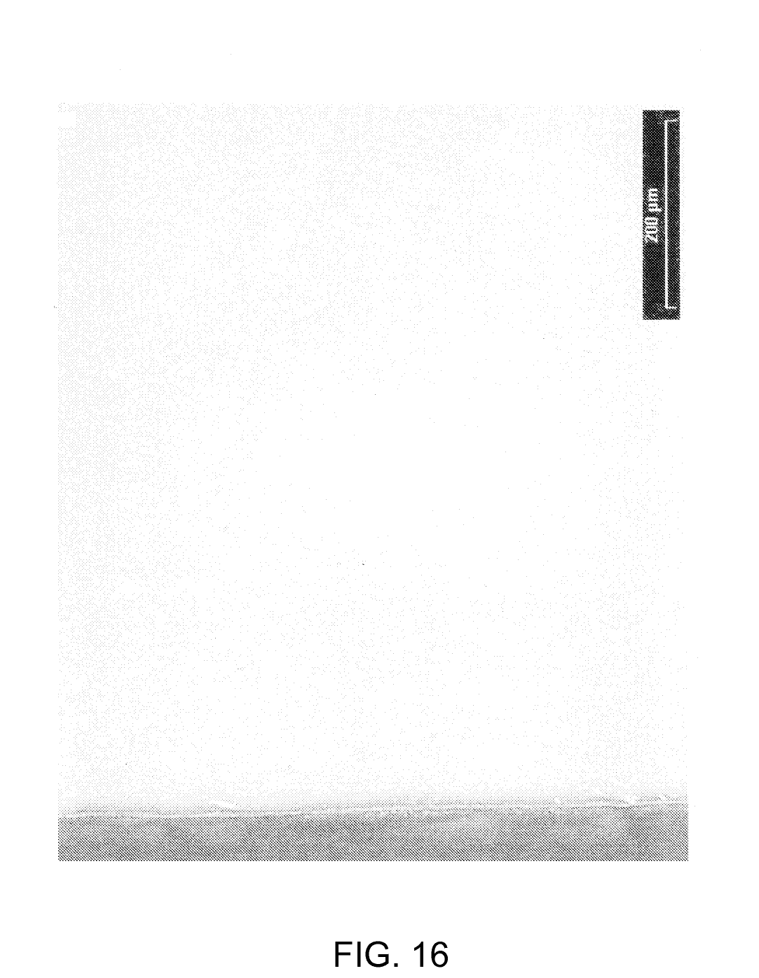

The pieces shown in FIG. 14 were cut from wires and embedded in plastic, ground down to the middle of the wire, then etched and pictures were taken though the microscope. The results of the inside structure of both wires can be seen in the next two figures. FIG. 15 is a cross section from a piece of high purity aluminum wire as presently in use in a variety of industrial applications. FIG. 16 is a cross section from a piece of high purity grain free aluminum wire as it can be used in a variety of industrial applications immediately.

FIG. 17 illustrates the principal of direct extrusion from the melt. The crucible on the left side contains the seed crystals which are inserted into the extrusion jet at the right side. After being in contact with the melt, the left side crucible is gradually, with increasing speed moved to the left.

This invention opens the gate into a new area of metals for electrical and other applications increasing the reliability in transport systems, reducing the environmental burden in a large scale by having high purity, light weight electrical conductors where environmental issues are at hand.

It is to be understood that the present invention is not limited to the sole embodiment described above, but encompasses any and all embodiments within the scope of the following claims.

I claim:

1. A direct extrusion system for metals with a grain free structure, comprising:
seed crystals;
a waiting melt into which the seed crystals are brought into contact, said melt being inside orifices of one or more extrusion jets at the bottom of a melting vessel;
a weight control system controlling inflow of liquid metal from a purifier system into the melting vessel, insuring that the same quantity of liquid metal flows in to the melting vessel as is extruded through the extrusion jets.

2. A direct extrusion system according to claim 1, wherein:
there are a plurality of extrusion jets;
there are different orifices in each of the extrusion jets; and
each extrusion jet produces a differently shaped product.

3. A direct extrusion system according to claim 1, further comprising:
an extrusion control system, interacting between the seed crystal, the feeder system from the purifier, and the weight control of the melting vessel, to insure that a continuous extrusion takes place at one or more extrusion jets.

4. A direct extrusion system according to claim 1, wherein aluminum products are produced by the system.

5. A direct extrusion system according to claim 1, wherein copper products are produced by the system.

6. A direct extrusion system according to claim 1, wherein gold products are produced by the system.

7. A direct extrusion system according to claim 1, wherein silver products are produced by the system.

8. A direct extrusion system according to claim 1, wherein wires are produced by the system.

9. A direct extrusion system according to claim 1, wherein rods are produced by the system.

10. A direct extrusion system according to claim 1, wherein tubes are produced by the system.

11. A direct extrusion system according to claim 1, wherein sheets are produced by the system.

12. A direct extrusion system according to claim 1, wherein foils are produced by the system.

13. A direct extrusion system according to claim 1, wherein extended products having regular cross sections are produced by the system.

14. A direct extrusion system according to claim 1, wherein extended products having irregular cross sections are produced by the system.

15. Grain free metal cable; comprising:
a core rod; and
segments around a core rod that reduce induction losses.

16. Grain free metal cable according to claim 15, wherein the aluminum the core rod and segments are aluminum.

17. Grain free metal cable according to claim 15, wherein the aluminum the core rod and segments are copper.

18. Grain free metal cable according to claim 15, wherein the cable is used in high-power cross-country lines.

19. Grain free metal cable according to claim 15, wherein the cable is used in high energy production systems.

20. A process of producing directional deformed products, comprising the steps of:
growing single crystals of metal in multiple crucibles; and
mechanically deforming the single crystals;
wherein the metal is selected from the group comprising aluminum, copper, gold and silver.
